(19) United States
(12) Patent Application Publication
(10) Pub. No.: US 2007/0084663 A1
(43) Pub. Date: Apr. 19, 2007

(54) Mounting structure of collision detection apparatus

(75) Inventors: Shingo Wanami, Kariya-city (JP); Toshiyuki Murai, Takahama-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/581,710

(22) Filed: Oct. 16, 2006

(30) Foreign Application Priority Data
Oct. 19, 2005 (JP) 2005-304350

(51) Int. Cl. B60K 28/10; G01N 3/00

(52) U.S. Cl. 180/274; 73/12.09

(57) ABSTRACT

A mounting structure of a collision detection apparatus for a vehicle has a vehicular member, a pressure sensor, and a shock absorbing member. The vehicular member defines a closed space therein. The shock absorbing member is disposed between the pressure sensor and a wall of the vehicular member. The pressure sensor is mounted to the wall of the vehicular member through the shock absorbing member in the closed space. The shock absorbing member is for example a nail-shaped spring member. Alternatively, the shock absorbing member can be a spacer having rubber elasticity.

### CROSS REFERENCE TO RELATED APPLICATION

This application is based on Japanese Patent Application No. 2005-304350 filed on Oct. 19, 2005, the disclosure of which is incorporated herein by reference.

### FIELD OF THE INVENTION

The present invention relates to a collision detection apparatus for determining whether or not to operate a passenger protection apparatus, particularly relates to a mounting structure of the collision detection apparatus to a vehicle.

### BACKGROUND OF THE INVENTION

A vehicle is generally provided with a passenger protection apparatus for protecting a passenger at a time of collision. As the passenger protection apparatus, for example, an air bag device for protecting the head of the passenger by expanding an air bag and a seatbelt pretentioner for tensioning a seatbelt are known. Such a passenger protection apparatus is generally controlled by a control unit (ECU). The ECU determines a collision of the vehicle based on a signal from a sensor mounted to a vehicle body. When the collision is determined, the passenger protection apparatus is operated.

In recent years, it is desired to improve safety for a collision on a broad side of the vehicle (i.e., side collision) in addition to a collision in a front and rear direction of the vehicle. To protect the passenger from the side collision, a side air bag is used. Also, a pressure sensor is mounted in a door of the vehicle for detecting a change of air pressure inside the door due to an impact load, so as to detect a side collision. Such a side air bag device is for example disclosed in Japanese Patent Publication No. 2-249740.

As shown in FIG. 10, the pressure sensor 3 for the side air bag device is for example mounted in a closed space 23 defined in a side door 2 of the vehicle. Further, as shown in FIGS. 11 and 12, the pressure sensor 3 is for example fixed to an inner panel 21 of the door 2 by using male screws 61 and female screws 62. The male screws 61 are threaded through the pressure sensor 3 and the inner panel 21.

In this structure, however, acceleration and deceleration components due to vibrations and impacts, which are generated such as while the vehicle travels on a rough load or when the door is strongly closed, are likely to be transmitted to a pressure detecting portion of the pressure sensor. Also in a case that the pressure sensor is firmly fixed to the door, the detection of the pressure detecting portion is likely to be affected by the vibrations and impacts, which are not caused by a collision.

### SUMMARY OF THE INVENTION

The present invention is made in view of the foregoing matter, and it is an object of the present invention to provide a mounting structure of a collision detection apparatus which will not be easily affected vibrations and impacts generated in situations other than a collision.

According to an aspect of the present invention, a mounting structure of a collision detection apparatus for a vehicle has a vehicular member, a pressure sensor and a shock absorbing member. The vehicular member defines a closed space. The pressure sensor is disposed in the closed space. The pressure sensor detects a pressure when a bulk of the closed space is changed with deformation of the vehicular member due to a collision. The shock absorbing member is disposed between the pressure sensor and the wall of the vehicular member. The pressure sensor is held on the wall of the vehicular member through the shock absorbing member inside of the closed space.

In this mounting structure, the shock absorbing member absorbs vibrations and impacts generated in the wall of the vehicular member. Namely, impacts and vibrations of the wall of the vehicular member will not be directly transmitted to the pressure sensor. Accordingly, it is less likely that the pressure sensor will detect the impacts and vibrations of the wall of the vehicular member as the change of pressure caused by the deformation of the vehicular member.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1A is a schematic sectional view of a side door of a vehicle provided with a collision detection apparatus according to a first example embodiment of the present invention;

FIG. 1B is an enlarged view of a part of the collision detection apparatus denoted by a circle IB in FIG. 1A;

FIG. 2 is a schematic sectional view of a pressure sensor of the collision detection apparatus fixed to an inner panel of the side door according to the first example embodiment;

FIG. 3 is a side view of the pressure sensor according to the first example embodiment;

FIG. 4 is a schematic sectional view of a pressure sensor of a collision detection apparatus according to a second example embodiment of the present invention;

FIG. 5 is a side view of the pressure sensor according to the second example embodiment;

FIG. 6 is a schematic sectional view of a pressure sensor of a collision detection apparatus according to a third example embodiment of the present invention;

FIG. 7 is a side view of the pressure sensor according to the third example embodiment of the present invention;

FIG. 8 is a schematic sectional view of a pressure sensor of a collision detection apparatus according to a fourth example embodiment of the present invention;

FIG. 9 is a side view of the pressure sensor according to the fourth example embodiment;

FIG. 10A is a schematic sectional view of a side door of a vehicle provided with a collision detection apparatus of a related art;

FIG. 10B is an enlarged view of a part of the collision detection apparatus denoted by a circle XB in FIG. 10A;

FIG. 11 is a schematic sectional view of a pressure sensor of the collision detection apparatus shown in FIG. 10A; and

FIG. 12 is a side view of the pressure sensor shown in FIG. 11.

### DETAILED DESCRIPTION OF EXAMPLE EMBODIMENTS

### First Example Embodiment

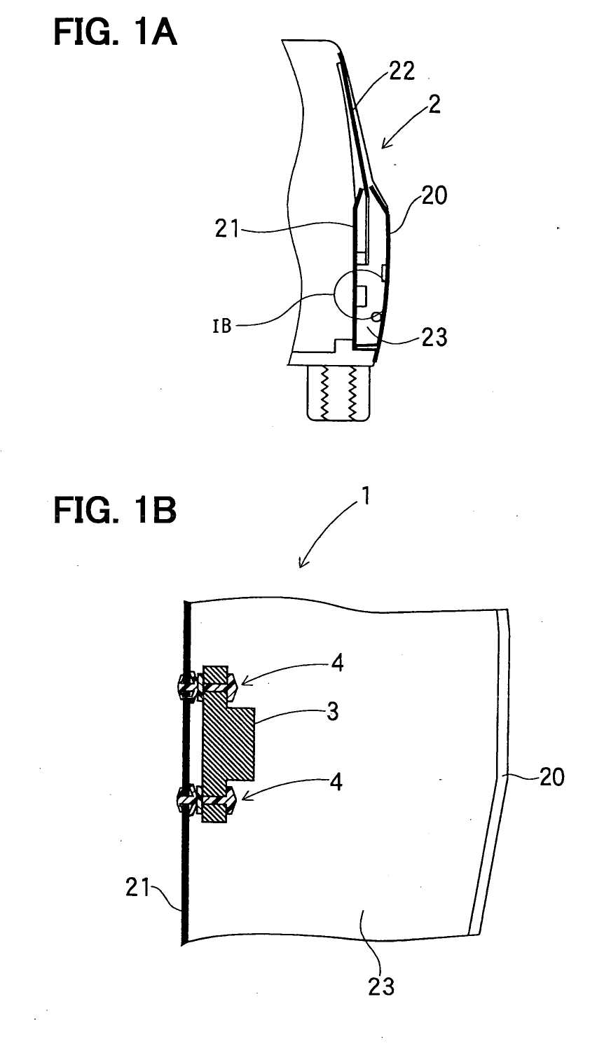

A first example embodiment of the present invention will be described with reference to FIGS. 1A through 3. A collision detection apparatus of a first example embodiment constitutes a part of a passenger protection apparatus. For example, the collision detection apparatus detects a side collision so as to trigger a side air bag for protecting a passenger at a time of side collision.

As shown in FIGS. 1A and 1B, the collision detection apparatus 1 is mounted to a side door 2 of a vehicle. The door 2 has an outer panel 20, an inner panel and a window glass 22. The outer panel 20 defines an outer wall of the vehicle. The inner panel 21 defines an inner wall facing a passenger compartment of the vehicle.

The outer panel 20 and the inner panel 21 form a closed space 23 between them. The closed space 23 is substantially closed. Namely, the closed space 23 is slightly in communication with an outside of the door 2. In other words, the closed space 23 is formed such that the pressure inside of the closed space 23 changes with a change of pressure outside of the door 2 and also changes with an instant change of the bulk of the closed space 23 e.g., due to deformation of the door 20.

The collision detection apparatus 1 is constructed of the inner panel 21, a pressure sensor 3 mounted in the closed space 23 and shock absorbing members 4. The pressure sensor 3 is fixed to the inner panel 21 through the shock absorbing members 4 in the closed space 23. The pressure sensor 3 is for example a diaphragm-type sensor.

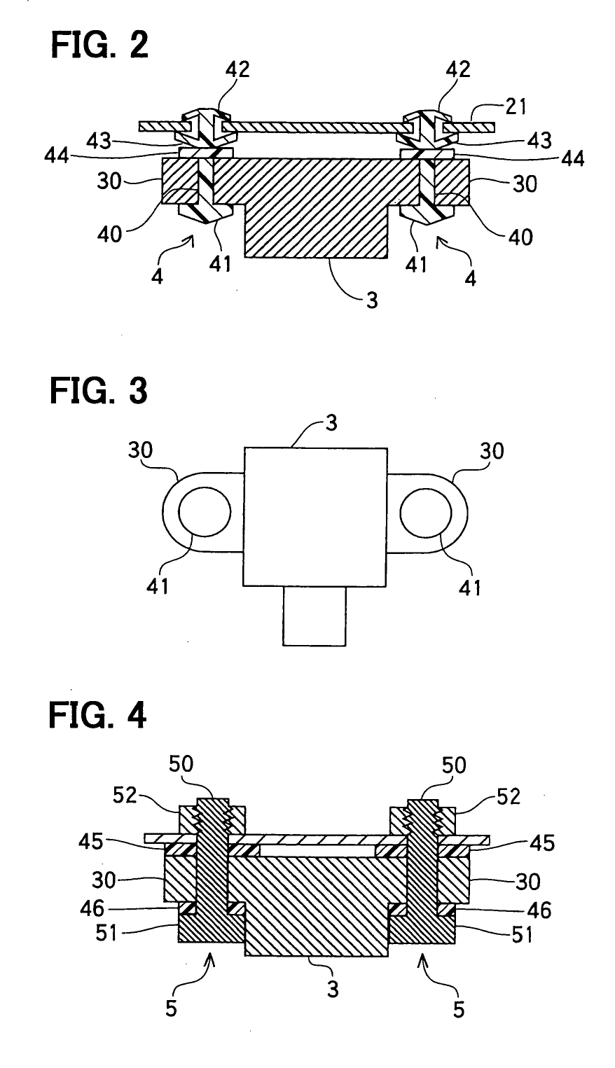

As shown in FIGS. 2 and 3, the pressure sensor 3 has fixing portions 30 on both sides, and the shock absorbing members 4 are inserted to the fixing portions 30 so as to fix the pressure sensor 3 to the inner panel 21. Each of the shock absorbing members 4 is a nail-shaped spring member.

For example, each shock absorbing member 4 is formed with a shaft portion 40, a head portion 41, a small nail-shaped spring 42, a large nail-shaped spring 43 and a nut 44. The shaft portion 40 is inserted into the fixing portion 30 of the pressure sensor 3 and the inner panel 21. The head portion 41 is integrally formed at an end of the shaft portion 40. The head portion 41 is located outside of the pressure sensor 3 on a side opposite to the inner panel 21 with respect to the pressure sensor 3.

The small nail-shaped spring 42 is integrally formed with the opposite end of the shaft portion 40 and is located on an inner side of the inner panel 21, the inner side facing the passenger compartment. The large nail-shaped spring 43 is integrally formed with the shaft portion 40 and is located between the pressure sensor 3 and the inner panel 21. Further, the nut 44 is located between the large nail-shaped spring 43 and the pressure sensor 3.

The small nail-shaped spring 42 is closed when it passes through the fixing portion 30 and the inner panel 21. After passing through the fixing portion 30 and the inner panel 21, the small nail-shaped spring 42 expands as shown in FIG. 2. Further, the small nail-shaped spring 42 retains an expanded shape so as not to be removed from the inner panel 21. As such, the pressure sensor 3 is supported on the inner panel 21 by the head portion 41 and the small nail-shaped spring 42.

The large nail-shaped portion 43 and the small nail-shaped portion 42 interpose the inner panel 21 between them, thereby fixing the pressure sensor 3 to the inner panel 21. The large nail-shaped spring 43 and the small nail-shaped spring 42 have elasticity and absorb vibrations and impacts even if the inner panel 21 is vibrated.

The shock absorbing member 4 is not limited to the above structure, but can be provided by a member that can fix the pressure sensor 3 to the inner panel 21 and absorb the vibrations and impacts of the inner panel 21 by its elasticity between the pressure sensor 3 and the inner panel 2. Preferably, the shock absorbing member 4 has a structure that has elasticity and can be fixed with one-touch operation to fix the pressure sensor 3 to the inner panel 21. Thus, the pressure sensor 3 can be easily fixed to the inner panel 21 without using a specific tool.

Further, the shock absorbing member 4 can be formed of a rubber bush or a member made of a material having elasticity, such as plastic. As such, vibrations and impacts generated in the inner panel 21 in situations other than a collision can be absorbed by the shock absorbing member 4. Accordingly, it is less likely that the pressure sensor 3 will be largely affected by the vibrations and impacts, which are not caused by a collision of the vehicle.

### Second Example Embodiment

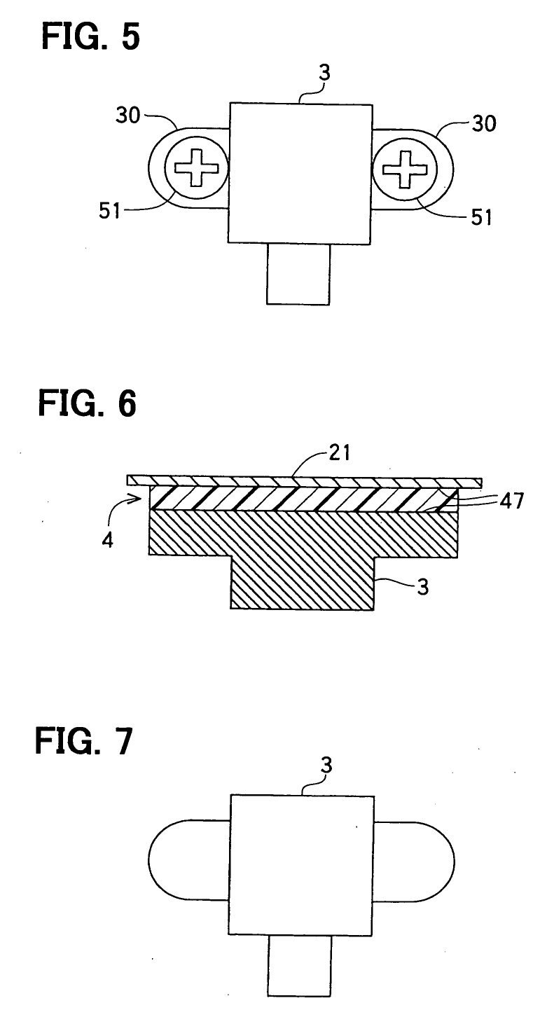

A second example embodiment will be described with reference to FIGS. 4 and 5. Similar to the first example embodiment, a collision detection apparatus of the second example embodiment constitutes a part of a passenger protection apparatus. For example, the collision detection apparatus of the second example embodiment detects a side collision for triggering a side air bag for protecting a passenger at a time of side collision.

In the second example embodiment, a structure of the shock absorbing member 4 and a method of fixing the pressure sensor 3 to the inner panel 21 are different from those of the first example embodiment. Other structural parts are similar to those of the first example embodiment. Here, like components are denoted by like reference characters and a description thereof is not repeated.

As shown in FIGS. 4 and 5, the pressure sensor 3 has the fixing portions 30 on both sides. The pressure sensor 3 is fixed to the inner panel 21 by using metal members 5. Each of the metal members 5 is constructed of a bolt formed with a shaft portion 50 and a head portion 51 and a nut 52. The shaft portion 50 is inserted in the fixing portion 30 and the inner panel 21. The head portion 51 is located at an end of the shaft portion 50 on a side opposite to the inner panel 21 with respect to the fixing portion 30 of the pressure sensor 3. The nut 52 is coupled to the shaft portion 50 on a side opposite to the head portion 51 and is located on inner side of the inner panel 21, the inner side located inside of the passenger compartment.

The shock absorbing member 4 has first spacers 45 and second spacers 46. Each of the first spacers 45 is interposed between the pressure sensor 3 and the inner panel 21. Each of the second spacers 46 is interposed between the head portion 51 and the pressure sensor 3. The first spacers 45 and the second spacers 46 are made of a material that can absorb impacts and vibrations generated in the inner panel 21 in situations other than a collision. For example, the first spacer 45 and the second spacer 46 are made of a material having rubber elasticity. As such, it is less likely that the impacts and vibrations of the inner panel 21 will be transmitted to the pressure sensor 3.

Here, the shape of the metal member 5 is not limited to a particular shape. For example, a general metal member having a bolt and a nut can be used as the metal member 5. Further, the shock absorbing members 4 can be easily interposed between the pressure sensor 3 and the inner panel 21 and between the pressure sensor 3 and the head portion 5 of the metal member 5.

### Third Example Embodiment

A third example embodiment will be described with reference to FIGS. 6 and 7. Similar to the first example embodiment, a collision detection apparatus of the third example embodiment constitutes a part of a passenger protection apparatus. For example, the collision detection apparatus of the third embodiment detects a side collision for triggering a side air bag for protecting a passenger at a time of side collision.

In the third example embodiment, a structure of the shock absorbing member 4 and a method of fixing the pressure sensor 3 to the inner panel 21 are different from those of the first example embodiment. Other structural parts are similar to those of the first embodiment. Here, like components are denoted by like reference characters and a description thereof is not repeated.

As shown in FIGS. 6 and 7, the shock absorbing member 4 is in a form of sheet having a predetermined thickness. The shock absorbing member 4 has rubber elasticity. The shock absorbing member 4 has adhesive surfaces 47 on both surfaces. The pressure sensor 3 is fixed to the inner panel 21 through the shock absorbing member 4. Specifically, the pressure sensor 3 is adhered to one adhesive surface 47 of the shock absorbing member 4 and the inner panel 21 is adhered to the opposite adhesive surface 47.

The shock absorbing member 4 absorbs impacts and vibrations generated in the inner panel 21 in situations other than a collision and restricts the impacts and vibrations from being transmitted to the pressure sensor 3. As such, it is less likely that the pressure sensor 3 will be largely affected by the impacts and vibrations generated in the inner panel 21 in situations other than the collision.

The shape of the shock absorbing member 4 is not particularly limited to a single sheet. For example, the shock absorbing member 4 can be formed of plural sheets as long as it can fix the pressure sensor 3 to the inner panel 21 with predetermined elasticity and predetermined adhesion strength. In this case, the sheets can be separately arranged at right and left ends and/or upper and lower ends of the pressure sensor 3.

The adhesive surface 47 can be formed of an adhesive agent or an adhesive tape. The shock absorbing member 4 provides an adhesive layer having rubber elasticity between the pressure sensor 3 and the inner panel 21. The pressure sensor 3 can be easily fixed to the inner panel 21 through shock absorbing member 4 without using a specific tool.

### Fourth Example Embodiment

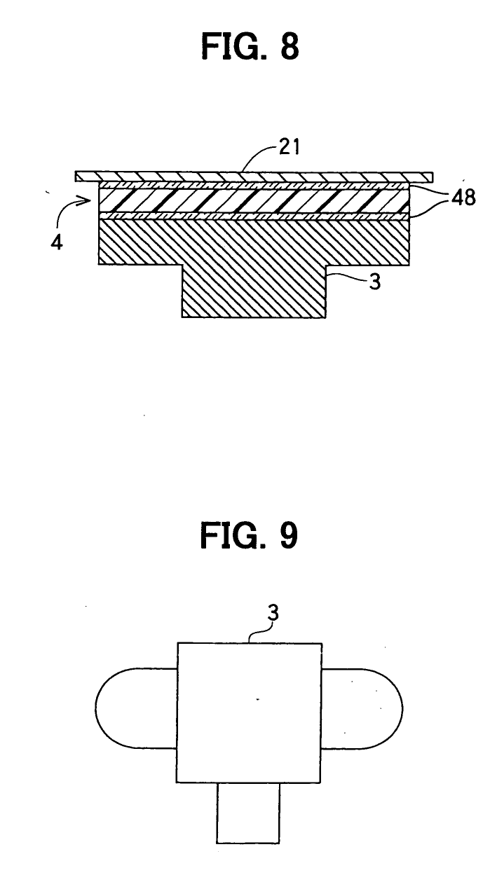

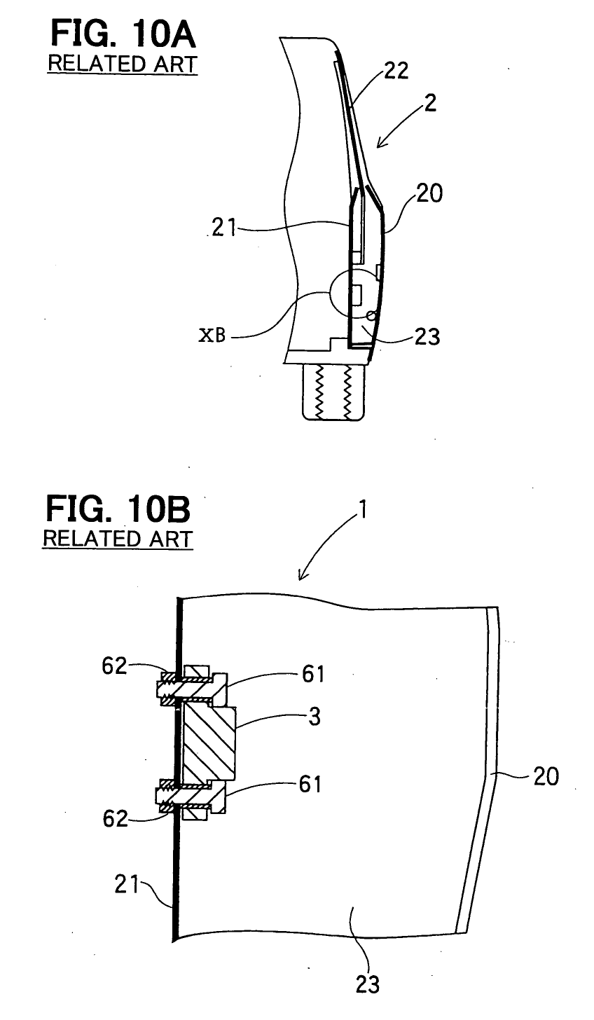

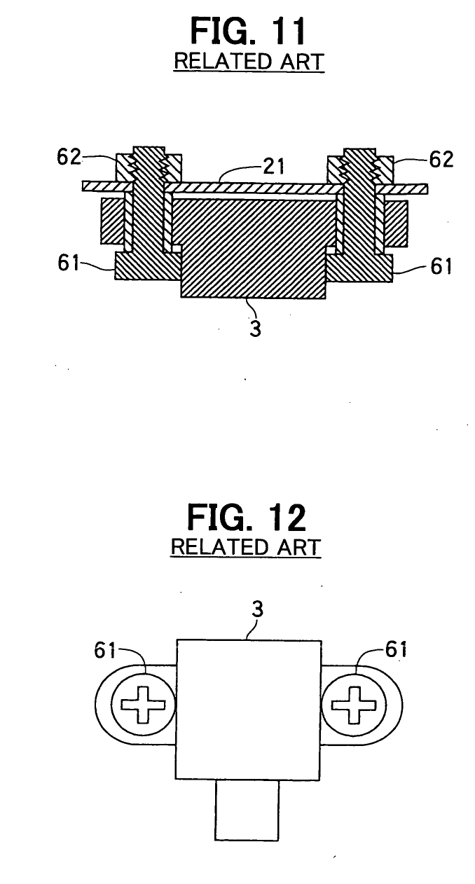

A fourth example embodiment will be described with reference to FIGS. 8 and 9. Similar to the first example embodiment, the collision detection apparatus of the fourth embodiment constitutes a part of a passenger protection apparatus. For example, the collision detection apparatus of the fourth embodiment detects a side collision for triggering a side air bag for protecting a passenger at a time of side collision.

In the fourth example embodiment, a structure of the shock absorbing member 4 and a method of fixing the pressure sensor 3 to the inner panel 21 are different from those of the first example embodiment. Other structural parts are similar to those of the first example embodiment. Here, like components are denoted by like reference characters and a description thereof is not repeated.

As shown in FIGS. 8 and 9, the shock absorbing member 4 is in a form of sheet having a predetermined thickness and has rubber elasticity as a spacer. Adhesive tapes 48 each having a predetermined size are adhered to both surfaces of the shock absorbing member 4. The pressure sensor 3 and the inner panel 21 are adhered to the surfaces of the shock absorbing member 4 through the adhesive tapes 48.

The adhesive tapes 48 have predetermined adhesive strength for sufficiently holding the pressure sensor 3 on the inner panel 21. It is not always necessary that the adhesive tapes 48 are adhered on entire surfaces of the shock absorbing member 4. For example, the adhesive tapes 48 can be adhered to portions of the shock absorbing member 4, e.g., at corner portions of the shock absorbing member 4 as long as the pressure sensor 3 is sufficiently held on the inner panel 21.

The shape of the shock absorbing member 4 is not limited to the single sheet as shown in FIG. 8. For example, the shock absorbing member 4 can be divided into plural portions and separately arranged at plural locations such as upper and lower portions and/or right and left portions of the pressure sensor 3. Further, the size of the adhesive tapes 48 can be changed as long as the pressure sensor 3 can be held on the inner panel 21 with sufficient adhesive strength.

Even if the impacts and vibrations are generated in the inner panel 21 in situations other than a collision, the shock absorbing member 4 absorbs the impacts and vibrations and restricts the impacts and vibrations from being transmitted to the pressure sensor 3. As such, it is less likely that the pressure sensor 3 will be largely affected by the impacts and vibrations caused by other than the collision. Here, an adhesive agent can be applied to the surfaces of the shock absorbing member 4 instead of the adhesive tapes 48.

In the above first to fourth embodiments, the pressure sensor 3 is provided for detecting a pressure when the pressure inside of the closed space 23 is changed with a change of bulk of the closed space 23 by deformation due to a collision of the vehicle. The pressure sensor 3 is fixed to the inner panel 21 through the shock absorbing member 4 inside the closed space 23. The door 2 will receive impacts and vibrate in situations other than a collision, e.g., when the vehicle travels on a rough load or when the door 2 is closed. In this case, the shock absorbing member 4 reduces or cancels components of the impacts and vibrations of the inner panel 21 to be transmitted to the pressure sensor 3. Thus, in the pressure sensor 3, vibration level due to the impact and vibrations will be reduced. As such, it is less likely that the pressure sensor 3 will erroneously detect a change of pressure in the closed space 23 generated in situations other than the collision.

In the above embodiments, it is preferable that resonance frequency of the pressure sensor 3 is reduced one-tenth or less of acceleration and deceleration frequency of the inner panel 21 by the shock absorbing member 4. By arranging the shock absorbing member 4 between the pressure sensor 3 and the inner panel 21, the acceleration and deceleration frequency of the inner panel 21 will be transmitted to the pressure sensor 3 in a degree of one-tenth or less.

As such, a resonance level of the pressure sensor 3 is reduced by a damping effect of the shock absorbing member 4. Therefore, it is less likely that the pressure sensor 3 will detect components of the impacts and vibrations of the inner panel 21 generated in situations other than the collision as a change of pressure due to a collision.

The shock absorbing member 4 of the above embodiments can be easily placed or adhered between the pressure sensor 3 and the inner panel 21. Therefore, the pressure sensor 3 can be easily mounted to the inner panel 21 even in a small closed space. Further, in the first, third and fourth example embodiments, the pressure sensor 3 is supported on the inner panel 21 by the shock absorbing member 4. Thus, the pressure sensor 3 can be easily mounted to the inner panel 21.

In the above embodiments, the mounting structure of the pressure sensor is employed to the pressure sensor 3 for detecting a side collision of the vehicle. However, the mounting structure using the shock absorbing member 4 can be employed to mount another sensor to a part of a vehicle. Further, a vehicular member on which the pressure sensor 3 is mounted is not limited to the inner panel 21. Also, the closed space 23 in which the pressure sensor 3 is mounted is not limited to the space defined between the inner panel 21 and the outer panel 20. Further, plural pressure sensors 3 can be mounted in the closed space 23.

The example embodiments of the present invention are described above. However, the present invention is not limited to the above example embodiments, but may be implemented in other ways without departing from the spirit of the invention.

What is claimed is:

1. A mounting structure of a collision detection apparatus for a vehicle, comprising:
a vehicular member defining a closed space therein;
a pressure sensor disposed in the closed space for detecting a pressure; and
a shock absorbing member, wherein the pressure sensor is held on the wall of the vehicular member through the shock absorbing member.

2. The mounting structure according to claim 1, wherein the shock absorbing member is one of a rubber member and a plastic member.

3. The mounting structure according to claim 1, wherein
the shock absorbing member is a nail-shaped spring member having a shaft portion and a nail portion,
the shaft portion extends through the pressure sensor and the wall of the vehicular member, and
the nail portion is located between the shaft portion and at least one of the pressure sensor and the wall of the vehicular member.

4. The mounting structure according to claim 1, wherein
the shock absorbing member includes a spacer having rubber elasticity,
the spacer is disposed between the pressure sensor and the wall of the vehicular member, and
the pressure sensor is fixed to the wall of the vehicular member through the shock absorbing member by a bolt and a nut.

5. The mounting structure according to claim 4, wherein
the shock absorbing member includes another spacer, and
the another spacer is disposed between the pressure sensor and one of the bolt and the nut.

6. The mounting structure according to claim 1, wherein
the shock absorbing member is a spacer having a rubber elasticity,
the spacer is disposed between the pressure sensor and the wall of the vehicular member, and
surfaces of the spacer are fixed to the pressure sensor and the wall of the vehicular member, respectively, through one of an adhesive agent and an adhesive tape.

7. The mounting structure according to claim 1, wherein
the shock absorbing member defines an adhesive layer having rubber elasticity between the pressure sensor and the wall of the vehicular member, and
the pressure sensor is joined to the wall of the vehicular member through the adhesive layer.

8. The mounting structure according to claim 1, wherein the shock absorbing member is disposed such that resonance frequency of the pressure sensor is equal to or less than one-tenth of acceleration and deceleration frequency of the wall of the vehicular member.

9. The mounting structure according to claim 1, wherein
the vehicular member is a door of the vehicle defining an outer wall of the vehicle, and the wall of the vehicular member is an inner panel of the door.

10. The mounting structure according to claim 1, wherein the pressure sensor detects a change of pressure of the closed space with a change of bulk of the closed space due to deformation of the vehicular member at a time of collision of the vehicle.

11. The mounting structure according to claim 1, wherein the pressure sensor is supported on the wall of the vehicular member by only the shock absorbing member.

12. A mounting structure for a vehicle, comprising:
a pressure sensor for detecting a pressure;
a member having a wall; and
a shock absorbing member having elasticity and supporting the pressure sensor on the wall of the member.

13. The mounting structure according to claim 12, wherein
the support member is a spring member having a shaft portion, a first nail-shaped spring portion and a second nail-shaped spring portion, the first nail-shaped portion and the second nail-shaped portion are integrated with the shaft portion,
the pressure sensor has a fixing portion and the shaft portion extends through the fixing portion of the pressure sensor,
the first nail-shaped spring portion is located between the fixing portion of the pressure sensor and the wall of the member, and
the first nail-shaped spring portion and the second nail-shaped spring portion interpose the wall of the member therebetween.
